(19) United States
(12) Patent Application Publication
(10) Pub. No.: US 2017/0011474 A1
(43) Pub. Date: Jan. 12, 2017

(54) MARKETING PROGRAM FOR HOSPITALITY INDUSTRY

(71) Applicants: Stephen Goldberg, Plymouth Meeting, PA (US); Dustin Majka, Ambler, PA (US)

(72) Inventors: Stephen Goldberg, Plymouth Meeting, PA (US); Dustin Majka, Ambler, PA (US)

(21) Appl. No.: 14/792,859

(22) Filed: Jul. 7, 2015

(51) Int. Cl. G06Q 50/12; G06Q 30/02; G06Q 30/06

(52) U.S. Cl. CPC G06Q 50/12; G06Q 30/0625; G06Q 30/0639; G06Q 30/0641; G06Q 30/0635; G06Q 30/0226

(57) ABSTRACT

A method for ensuring accurate display of information on a display device receiving data from a database, the method including requiring an acknowledgement at a frequency from a responsible party of at least one establishment of a piece of data from the database, the piece of data is associated with an address, providing a means for receiving the acknowledgement, determining the relevance of the piece of data based on its associated address with respect to the current location of the display device, whereby if the acknowledgement is not received, the piece of data is marked as deactivated in the database such that it is prevented from being presented in the display device and if the piece of data is determined to be relevant, the piece of data is not prevented from being displayed on the display device.

### BACKGROUND OF THE INVENTION

1. The Field of the Invention

The present invention is directed generally to a marketing program for the hospitality industry. More specifically, the present invention is directed to a marketing program which makes available items or services for comparison by users based on the users' geolocation.

2. Background Art

Conventional restaurant advertising or marketing allows a user to bring up some information from various merchants, regardless of whether the information is current. Merchants often spend time and effort to set up an account to handle advertising on the internet properly initially but fail to maintain the account, making the advertised items obsolete. For instance, a search for local restaurants on Google® Maps® returns results or listing of restaurants considered geographically close to a mobile device from which the search is performed or around a zip code. Each result typically includes access to a link to a menu, direction guidance to the restaurant, the name, address, contact information via traditional means, e.g., phone number, email address, social media interfaces (e.g., Facebook®, Google+®, Twitter®) and operating hours of the restaurant, reservations portal (e.g., via OpenTable™), reviews, level of price and rewards, etc. Typically, the link to a menu includes a hyperlink to a website hosted and maintained by the merchant's own web hosts and/or the merchant. The interface to such a web site on the hyperlink is typically cumbersome, requiring direct modification of web pages or data files prepared as simple text or spreadsheet documents, skills which are not necessarily easily available to the merchant. Each interface also has its own style or flair and the information presented may not be consistent. For instance, one merchant may present only a menu item without specifying the price associated with such an item. The rendering of the backdrop upon which the menu item is posted may not be suitable to allow a user to quickly discern the description or price from the background. Worse yet, the merchant may not even have a valid web address or web page or the web page may not have been optimized to be downloaded and displayed within a delay reasonable for the user to wait. Further, poor user experience can also stem from inaccurate information, e.g., if displayed food or drink items have been out of stock or otherwise unavailable. Typical menus also fail to specify the serving sizes of items. The failure to specify serving sizes can affect users in the following manner. The user who expects a larger portion will be disappointed due to price and insufficiency and the user who expects a smaller portion will have to deal with wastes and left-overs. Users who had poor experience due to one or more of these deficiencies disclosed above tend to not return for additional searches, essentially making overall merchants' effort in advertising and marketing unsuccessful. As a result, merchants are then not keen on maintaining advertising of their items and services through such systems and methods, making this a cyclical problem, i.e., the merchants rely on users' usage to make such advertising a success while the users expects useful advertising from merchants before they are willing to engage the advertisements. Successful advertising by a merchant can only be realized if the user base is sufficiently large and that a sufficient pool of merchants that provides accurate information for users' consumption is available.

Further, many merchants make changes to their offerings on a daily basis and it is often difficult and/or impossible for consumers to know what these changes are, especially if a merchant does not maintain its website on a timely basis. Yet further, is it not currently possible for a user to view current daily information across many merchants at the same time with one action.

Thus, there is a need for a system and method capable of providing reliable information to the users and a system and method capable of presenting daily information across many merchants simultaneously with one action, which in turn result in a system and method that is more effective in connecting offers by merchants to users, thereby increasing the merchants' sales and making the user's purchase of the merchants' offers easier.

### SUMMARY OF THE INVENTION

The present invention meets the above-identified needs by providing systems and methods for facilitating the presentation of merchants' offers that are highly relevant to users and a means allowing users to make comparisons of the merchants' offers.

In accordance with the present invention, there is provided a method for ensuring display of relevant information on a display device receiving data from a database, the method including:
(a) requiring an acknowledgement at a frequency from a responsible party of at least one establishment of a piece of data from the database, the piece of data is associated with an address;
(b) determining the relevance of the piece of data based on its associated address with respect to the location of the display device,
   whereby if the acknowledgement is not received, the piece of data is marked as deactivated in the database such that it is prevented from being presented in the display device and if the piece of data is determined to be relevant, the piece of data is not prevented from being displayed on the display device. In one embodiment, the frequency is daily. The location can be the current location of the display device or a specified location, e.g., a zip code. In one embodiment, the information includes the availability and pricing corresponding to the at least one piece of data of the at least one establishment. In one embodiment, the information further includes the serving size corresponding to the at least one piece of data. In one embodiment, the information includes the availability and pricing of no more than about three items corresponding to the at least one piece of data of the at least one establishment on a landing page. In one embodiment, the information is displayed in a top-down list format. In one embodiment, the at least one establishment is a food establishment.

A two-way order-placing interface is enabled. Upon display of an item on a user's display device, an order for the item is configured to be placeable through the two-way order-placing interface and communicated to the merchant and communication from the merchant is configured to be communicable to the user.

A two-way reservation interface is enabled. Upon display of an item on a user's display device, a reservation for the location by the user is configured to be placeable through the two-way reservation interface and communicated to the merchant and communication from the merchant is configured to be communicable to the user.

A two-way loyalty program is enabled. Upon the purchase of an item, a user may request loyalty points from the merchant. The merchant may grant the user the requested loyalty points.

Accordingly, it is an object of the present invention is to provide a system and method that ensures that merchant offers presented to users are highly relevant.

An object of the present invention is to provide a system and method that allows a user to make comparisons of products and/or services which are highly relevant to the user.

An object of the present invention is to provide a system and method that presents merchant offers based on geolocation of users, therefore making the offers highly relevant to the users.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of an exemplary hardware setup for the marketing program according to the present invention.

FIG. 2 is a flowchart depicting a mechanism for ensuring an item scheduled to be offered is still being offered.

FIG. 3 is a block diagram of an exemplary software system useful for implementing the present invention.

FIG. 4 is a screenshot of a merchant dashboard.

FIG. 5 is a screenshot of a merchant dashboard, depicting examples of categories of items requiring daily acknowledgment that are revealed as a list of categories.

FIG. 6 is a screenshot of a merchant dashboard, depicting a summary of examples of categories of items requiring daily acknowledgment.

FIG. 7 is a screenshot of a merchant dashboard, depicting a category of items requiring daily acknowledgment.

FIG. 8 is a screenshot of a merchant dashboard, depicting a step to initiate the addition of an item requiring daily acknowledgment.

FIG. 9 is a screenshot of a merchant dashboard, depicting an interface for adding an item requiring daily acknowledgment.

FIG. 10 is a screenshot of a merchant dashboard, depicting a step to import one or more items requiring daily acknowledgment.

FIG. 11 is a screenshot of a merchant dashboard, depicting examples of items related to takeout orders that are revealed as a list.

FIG. 12 is a screenshot of a merchant dashboard, depicting examples of items related to new takeout orders.

FIG. 13 is a screenshot of a merchant dashboard, depicting examples of items related to pending takeout orders.

FIG. 14 is a screenshot of a merchant dashboard, depicting examples of items related to takeout orders waiting for pickup.

FIG. 15 is a screenshot of a merchant dashboard, depicting examples of items related to past takeout orders.

FIG. 16 is a screenshot of a merchant dashboard, depicting a mechanism for conveying messages quickly to users.

FIG. 17 is a screenshot of a merchant dashboard, depicting examples of reservation related items revealed as a list.

FIG. 18 is a screenshot of a merchant dashboard, depicting examples of reservation requests.

FIG. 19 is a screenshot of a merchant dashboard, depicting examples of accepted reservations.

FIG. 20 is a screenshot of a merchant dashboard, depicting examples of rejected/cancelled reservations.

FIG. 21 is a screenshot of a merchant dashboard, depicting examples of settings items for a merchant.

FIG. 22 is a screenshot of a merchant dashboard, depicting examples of push notifications to users.

FIG. 23 is a screenshot of a merchant dashboard, depicting examples of a template construction interface.

FIG. 24 is a screenshot of a merchant dashboard, depicting examples of items related to a loyalty program where the examples are revealed as a list.

FIG. 25 is a screenshot of a merchant dashboard, depicting examples of items related to loyalty rewards.

FIG. 26 is a screenshot of a merchant dashboard, depicting examples of items related to loyalty point rewards.

FIG. 27 is a screenshot of a merchant dashboard, depicting examples of items related to loyalty history.

FIG. 28 is a screenshot of a user display device, depicting a default screen example displaying a list of merchants in the vicinity of the user display device starting from the merchant geographically closest to the user display device.

FIG. 29 is a screenshot of a user display device, depicting an example screen displaying a short list of items offered by a merchant.

FIG. 30 is a screenshot of a user display device, depicting an example screen displaying a long list of items offered by a merchant.

FIG. 31 is a screenshot of a user display device, depicting an example screen displaying a description detailing an item.

FIG. 32 is a screenshot of a user display device, depicting another example screen displaying a short list of items offered by a merchant.

FIG. 33 is a screenshot of a user display device, depicting yet another example screen displaying a short list of items offered by a merchant.

FIG. 34 is a screenshot of a user display device, depicting a search interface available to a user for merchants meeting listed criteria.

FIG. 35 is a screenshot of an account login interface where a logged in user can communicate with a merchant.

### PARTS LIST

2—central system
4—central repository
6—web servers
8—merchant's computer
10—user's computer
12—internet
14—cellular network
16—communication between Global Positioning System (GPS) satellite and mobile device
18—communication between cellular network and mobile device
20—communication between internet and mobile device
22—GPS satellite
24—Wi-Fi facility
26—mobile device or user display device
28—step of setting up and activating item to be offered
30—step of requesting acknowledgment from merchant
32—step of acknowledging that item scheduled to be offered is still being offered
34—application software
36—web portal
38—web services
40—merchant dashboard
42—merchant login interface
44—reporting system
46—daily update services
48—reservation services
50—communication between user display device and web servers
52—takeout order services

### PARTICULAR ADVANTAGES OF THE INVENTION

The present system and method ensures that information is presented in up-to-date and relevant, boosting the users' confidence that the information can be relied upon and the merchants' confidence that the system and method is being utilized, therefore effective in marketing items or services to relevant users.

Order and reservation services are two-way services which enable not only order-taking or reservation-receiving on the merchant end but also communications from the merchant end to the user end.

Existing food services offer piece-meal solutions which offer few services, e.g., reservation only, menus that are incomplete, non-functional or obsolete, menus that are not searchable, making it difficult for users to compare menu items from multiple merchants and menus that do not indicate serving sizes. The present system and method is a holistic solution connecting the needs of users to merchants who offer services which meet their needs.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

In the context of a food establishment, the term “item,” “product,” or “merchandise” is used herein to mean any combination of one or more food and drink items and/or food and drink related services.

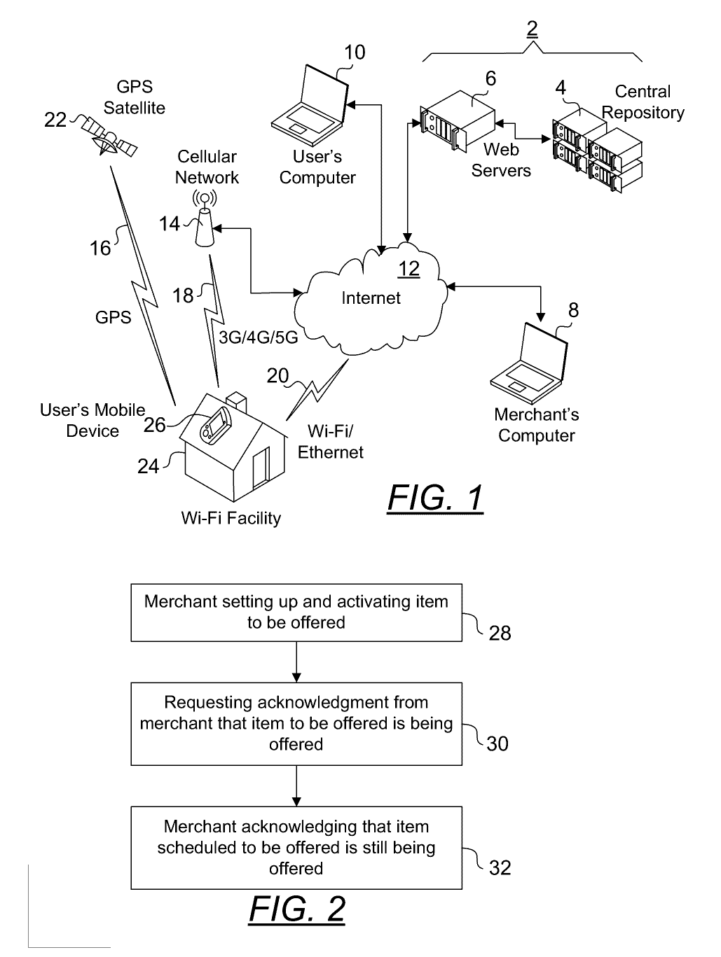

FIG. 1 is a block diagram of an exemplary hardware setup for the marketing program according to the present invention. As will be appreciated by those skilled in the relevant art(s) after reading the description herein, in an aspect, a web application executes on one or more web servers 6 (as shown in FIG. 1) providing one or more websites which send out web pages in response to Hypertext Transfer Protocol (HTTP) or Hypertext Transfer Protocol Secured (HTTPS) requests from remote browsers. Such web servers 6 are able to provide a graphical user interface (GUI) to users of the device 26 and the merchant's computer 8 or other devices utilizing the web application of the web servers 6 in the form of web pages. These web pages are sent to device 26, merchant's computer 8, user's computer 10, laptop, mobile device, Personal Digital Assistant (PDA) or like terminal devices and result in the GUI screens being displayed.

As will also be appreciated by those skilled in the relevant art(s) after reading the description herein, in an aspect, an application service provider (i.e., an entity providing the infrastructure for one or more merchants or users) with multiple locations at one or more corresponding URLs) may allow access, on a paid subscriber/membership, and/or pay-per-use basis, to the tools (i.e., web application). The present invention provides a means for offering items for sale or services which are highly relevant to the user at the time and location when such offers are viewed.

The systems and methods for ensuring an item or service scheduled to be offered is highly relevant, or any part(s) or function(s) thereof, may be implemented using hardware, software or a combination thereof and may be implemented in one or more computer systems or other processing systems as shown in FIGS. 1 and 2. However, the manipulations performed by the present invention were often referred to in terms, such as “requesting,” “setting up,” “activating” or “acknowledging,” which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers, smart phones, tablets, pads and similar devices. Referring back to FIG. 1, the device 26 can include a communication module which services 3^{rd} generation (3G), 4th generation (4G), 5^{th} generation (5G) or newer mobile telecommunication standards, ethernet and wireless fidelity (Wi-Fi) communication with respective networks and a GPS sensor for providing geographical locations.

FIG. 2 is a flowchart depicting a mechanism for ensuring an item scheduled to be offered is still being offered. The method ensures accurate display of information on a display device. The data for such display is configured to be received from a database that is stored in a storage, e.g., central repository 4. Merchants can enter data through the merchant's computer 8 and the data is selectively displayed on users' application running either in the user's computer 10 or user's mobile device 26. In order to use the present system, a merchant is provided an interface to set up his account having a profile unique to the merchant. As shown in step 28, the merchant can then enter information pertaining to items and services tailored to be offered to users accessing such offers. The information can include the name of an item, its corresponding price, time and date ranges in which the items or services are available, its corresponding discount coupon, specials, etc. Upon entering the information, the merchant can select whether or not to offer the items or services by selecting the items or services to be activated or simply leaving the items inactivated for future use. A merchant will only need to enter information on items or services once and then select the items or services to be offered on a daily basis.

A means for receiving an acknowledgement is provided. As long as an acknowledgment is provided prior to the period in which an item or service is offered by the merchant, the item or service will be made available during the scheduled time. The status of an acknowledged or confirmed item or service is termed “activated” while an item or service that has already been entered in a merchant's database but otherwise not made active is termed “inactivated.” An item or service having a status of “inactivated” will not be searched and displayed on a user's display device when such item or service is searched. In determining whether to display items or services on a display on a user's machine, the relevance of the items or services is determined. In one embodiment, the relevance of an item or service is determined by comparing the location at which the item or service is offered to the current location of the display device or a zip code. The location can be expressed as a set of latitude and longitude information which is an estimate of the merchant's place of business or where items and services are offered by the merchant. If the location at which the item or service is offered is within a pre-determined distance from a user's device, the item or service of the location is considered relevant. In step 30, a request for confirmation of the previously activated items or services is provided. In ensuring that information is up-to-date, the merchant must acknowledge, as in step 32, at a frequency, prior to the period in which the items or services are scheduled to be offered, that the items or services will be offered. In one embodiment, the frequency is daily. A request can be programmed to be automatically sent to the merchant, e.g., via email, text or directly to the merchant's dashboard 40, to request confirmation from a merchant that the items or services scheduled to be offered are indeed being offered. The request is received at the merchant dashboard, prompting the merchant to make such confirmation. In one embodiment, when the request is sent at a pre-programmed amount of time prior to the offering of the items or services scheduled to be offered. If confirmation has not been received prior to the time the items or services are scheduled to be offered, such offers are deactivated. In another embodiment, no such request is made. The merchant is simply expected to provide confirmation prior to scheduled offers. In all cases, the status of each offered item or service is automatically deactivated upon the end of a scheduled offer period, making it necessary to provide confirmation to make the item or service activated in the next scheduled offer period. In one embodiment, and less desirably, the frequency is weekly. In the latter, a weekly view of offered items is available to merchants and the merchant may acknowledge the offered items prior to their offer to users. Each item or service offered is associated with a merchant having a physical address. A merchant may represent a manager of an establishment or any responsible party for the establishment, e.g., restaurant, and any other food or drink items.

In one embodiment, the item or service includes the availability and pricing of at least one item of at least one merchant. In one embodiment, the at least one merchant is a food establishment, e.g., restaurant, bar, etc. In one embodiment, the number of items or services displayed on a landing page of a user's display device is limited to three. In one embodiment, items or services of each merchant are displayed in a top-down list format, allowing the items or services to be compared in a top-down format.

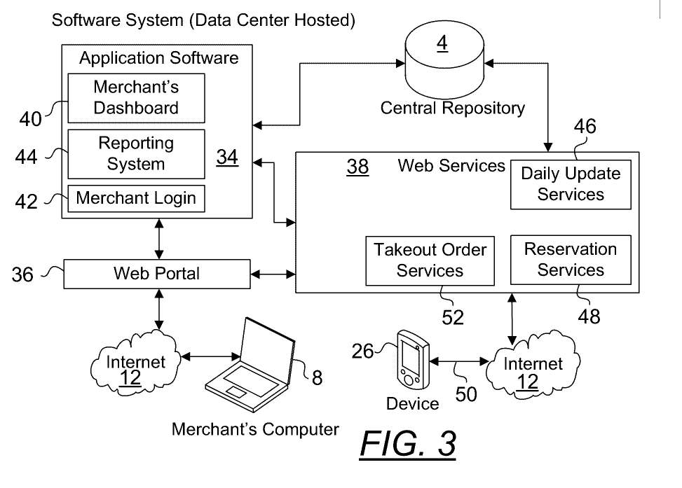

FIG. 3 is a block diagram of an exemplary software system useful for implementing the present invention. The exemplary software system includes an application software 34, web portal 36 and web services 38 which in one embodiment, are loaded to and executable in at least of one of the web servers 6. The application software 34 can include a merchant dashboard 40 where a merchant can visit and see the status of all the activities associated with its users. The application software 34 also includes, but not limited to, a reporting system 44 for aggregating information pertinent to offers, reservations, daily update services 46, reservation services 48, takeout order services 52 and a merchant login interface 42 useful to facilitate login of a merchant. At any time, a merchant can make changes to the information stored in the central repository 4 where such information can be communicated to a user via a display device 26. Referring to FIGS. 1 and 3 and as will also be appreciated by those skilled in the relevant art(s) after reading the description herein, in an aspect, the traffic 50 between the device 26 and a computer (e.g., web servers 6 and merchant's computer 8) or all other devices operably connected to the present invention is routed through one of the networks (e.g., cellular 18, Wi-Fi or Ethernet 20) and the internet 12. The central repository 4 is operably connected to both the application software 34 and the web services 38 such that information pertinent to the items or services to be offered, and any information of the merchants or users can be stored and retrieved. The web portal 36 provides an interface where the merchant can access via the merchant's computer 8 and the internet 12 to take advantage of any of the services available in the application software 34 and the web services 38.

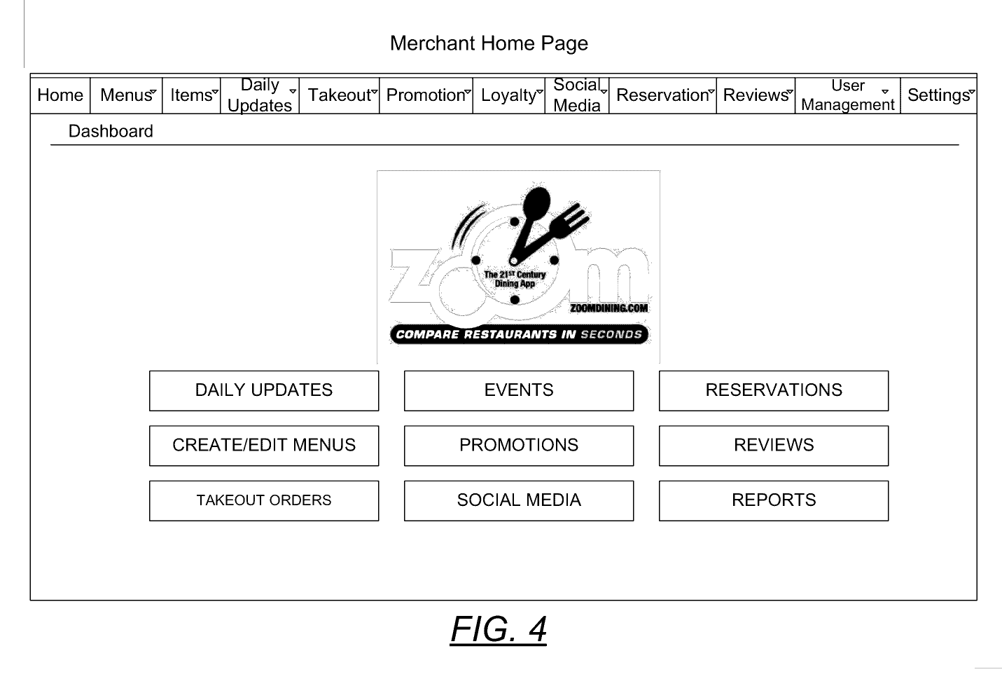

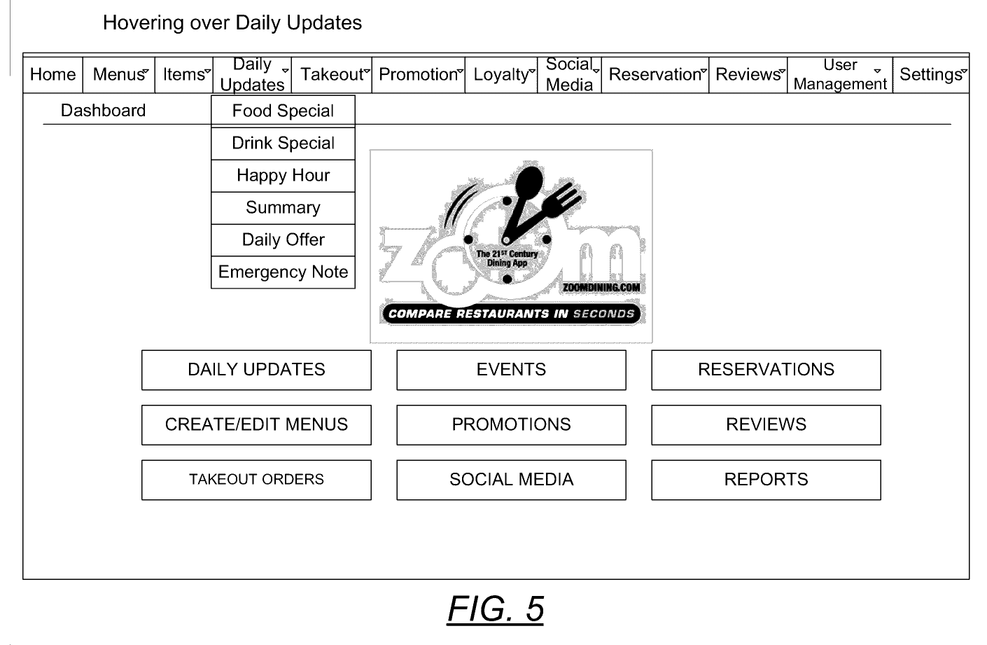

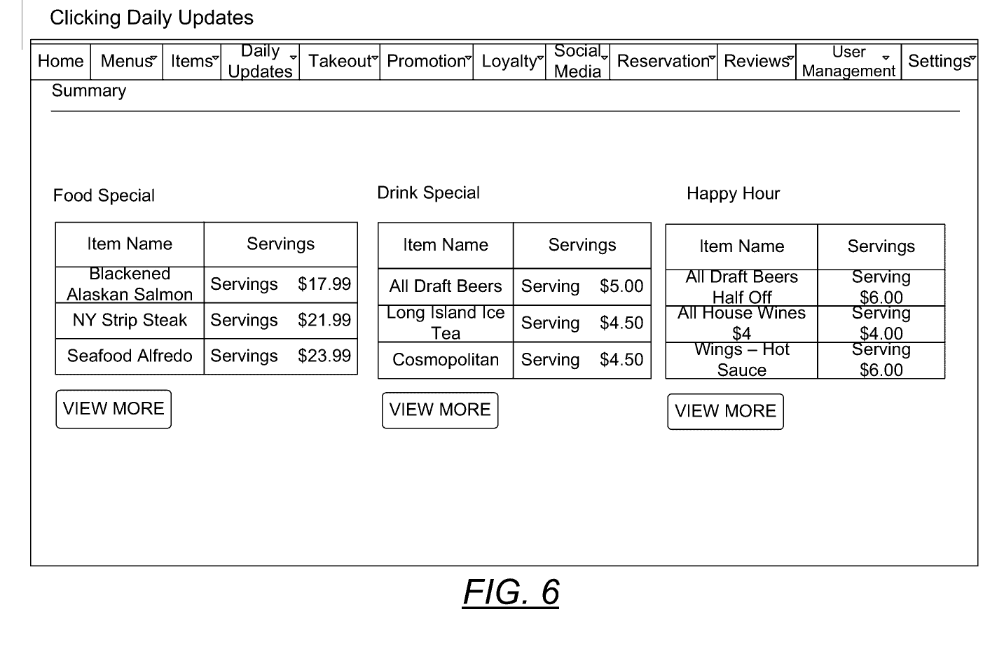

FIG. 4 is a screenshot of a merchant dashboard configured as part of the web portal 36 of FIG. 3. It shall be noted that the dashboard includes links to important functions requiring daily attention, e.g., daily updates, reservations and takeout orders among several other services. FIG. 5 is a screenshot of a merchant dashboard, depicting examples of categories of items requiring daily acknowledgment revealed as a list. FIG. 6 is a screenshot of a merchant dashboard, depicting a summary of examples of categories of items requiring daily acknowledgment. As shown in the pull-down list, various categories of items requiring daily attention include offers, e.g., “Food Special,” “Drink Special,” and “Happy hour.”

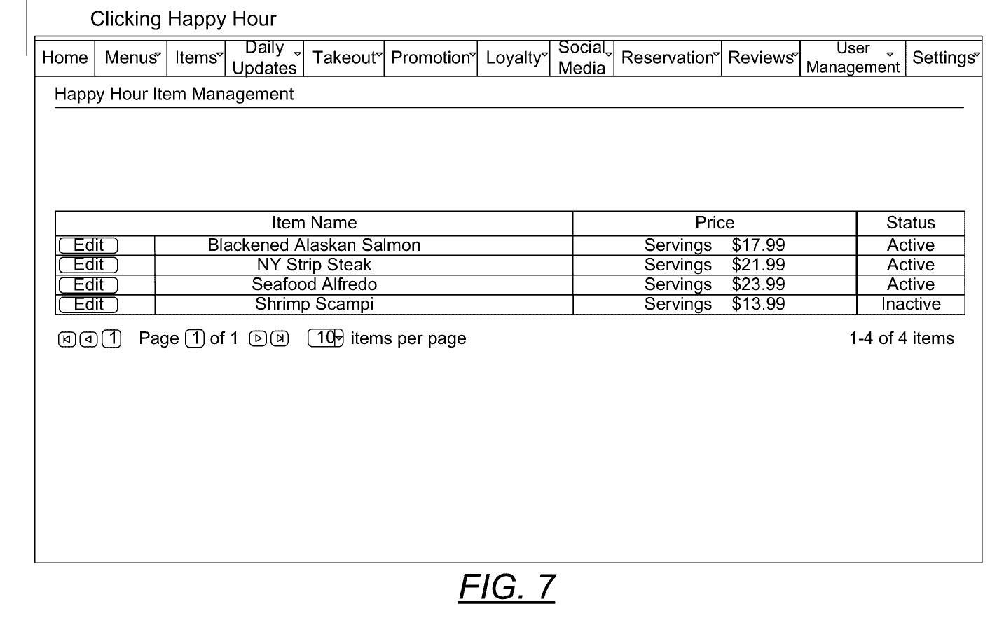

FIG. 7 is a screenshot of a merchant dashboard, depicting a category of an item requiring daily acknowledgment. Once entered, the list of items may be activated or deactivated at the press or toggle of a button. Mass activation of items within a category of items is also possible. A merchant may select all of the items within a category with one click, simplifying the step of acknowledging that the items are activated to be offered at scheduled time. Items may also be activated or deactivated individually by merely selecting the item having a status to be altered. As shown, an item scheduled to be offered is given a status of “Active” while a status of “Inactive” is given to an item not offered at the scheduled period, e.g., in this example, item “Shrimp Scampi” is shown as “Inactive” or deactivated or not offered. At the end of each period in which an item is scheduled to be offered, the status of the item is automatically defaulted to “deactivated.” Therefore, in order to offer the item in the next period, an acknowledgment that the item will be offered is required, i.e., changing the status from “Inactive” to “Active.” The Applicant discovered that, although this mechanism increases the number of steps to post an item on a user's display device, the user confidence in the availability of an offered item or service is increased tremendously as the information displayed on a user's display requires such acknowledgment or confirmation.

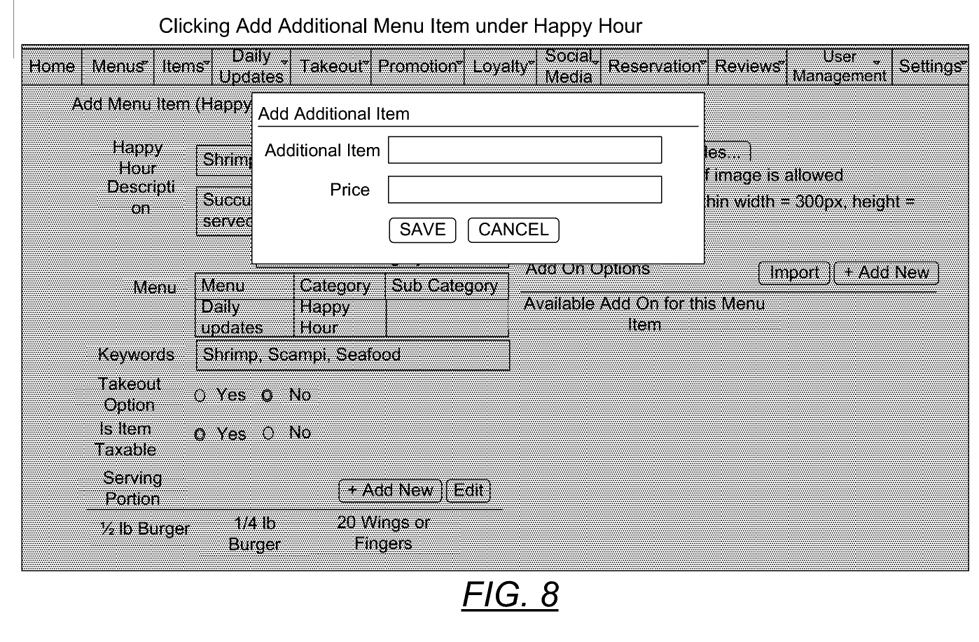

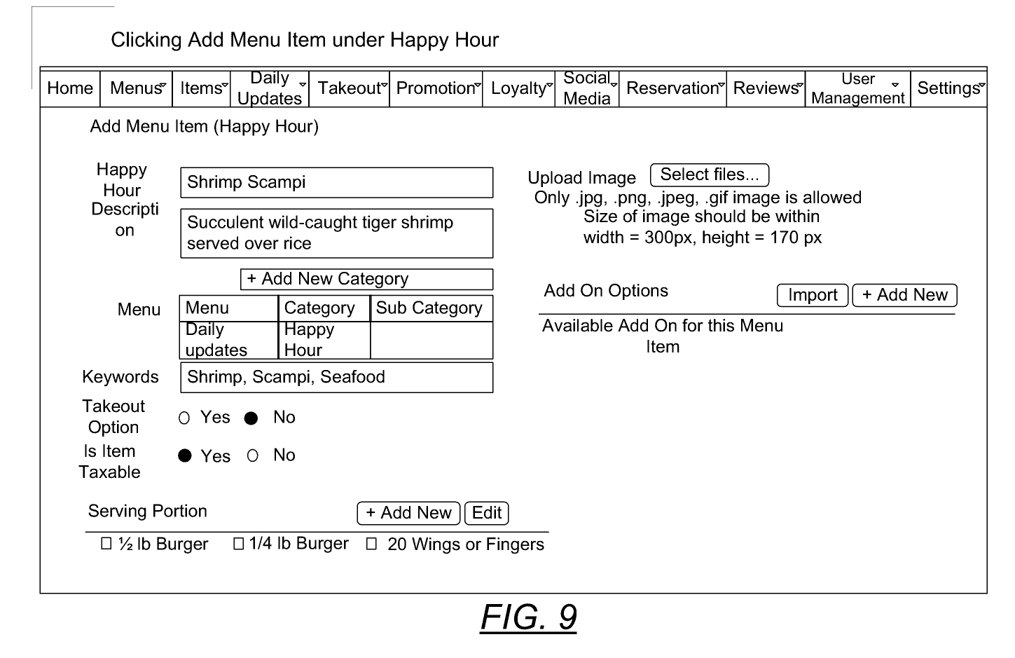

FIG. 8 is a screenshot of a merchant dashboard, depicting a step to initiate the addition of an item requiring daily acknowledgment. FIG. 9 is a screenshot of a merchant dashboard, depicting an interface for adding an item requiring daily acknowledgment. An item may be added in one of several ways. Upon having generated an item category, an item may be added and placed automatically under this category. Upon navigating to a desired category with the desired item indicated, the interface for adding an item is initiated by clicking the “Add New” button. The name of an item and its corresponding price are entered and saved. An item may also be entered with the category eventually selected from a pull-down list or identified with a newly created category. If the category designation is not altered, the already available category will be adopted.

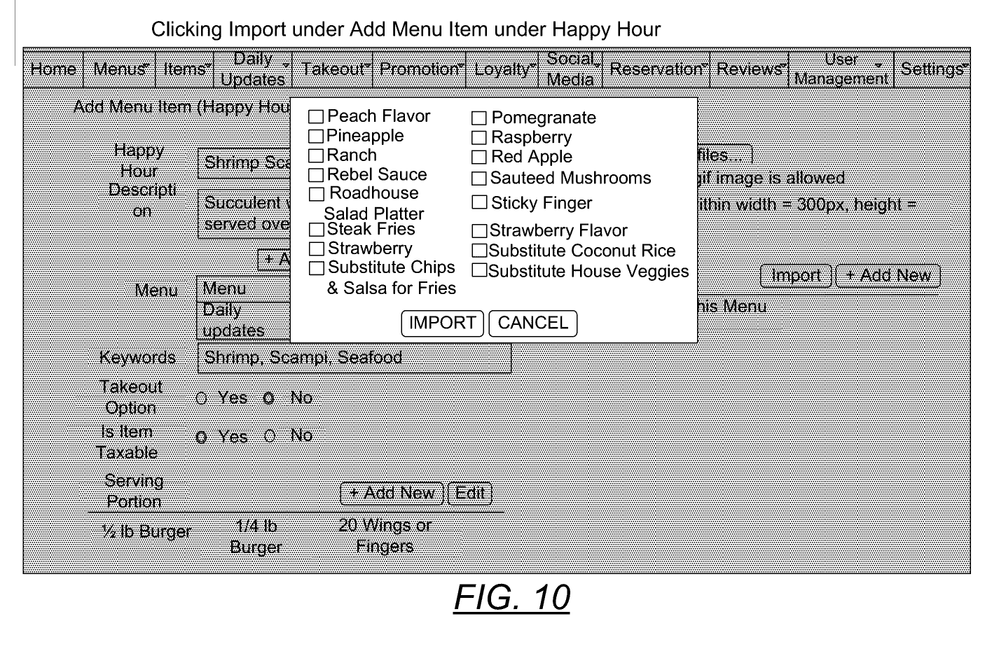

FIG. 10 is a screenshot of a merchant dashboard, depicting a step to import one or more items requiring daily acknowledgment. In one embodiment, a large list of conceivable items may be provided to merchants, allowing the merchants to simply import items instead of creating items from scratch. The imported items may also be modified. Imported items may default to the “Inactive” status. Therefore, in order to include such items in the users' display device, the status of such items must be changed to “Active.” This capability allows a merchant to more quickly set up an account initially and provide a full menu of food and drink products, further encouraging the use of such a system and method by the merchant.

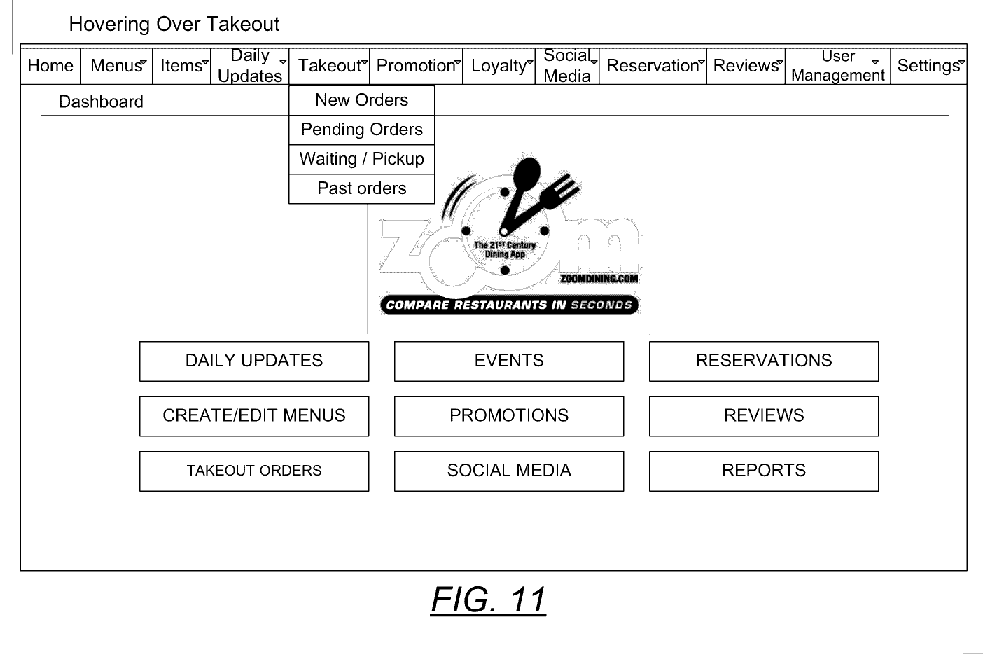

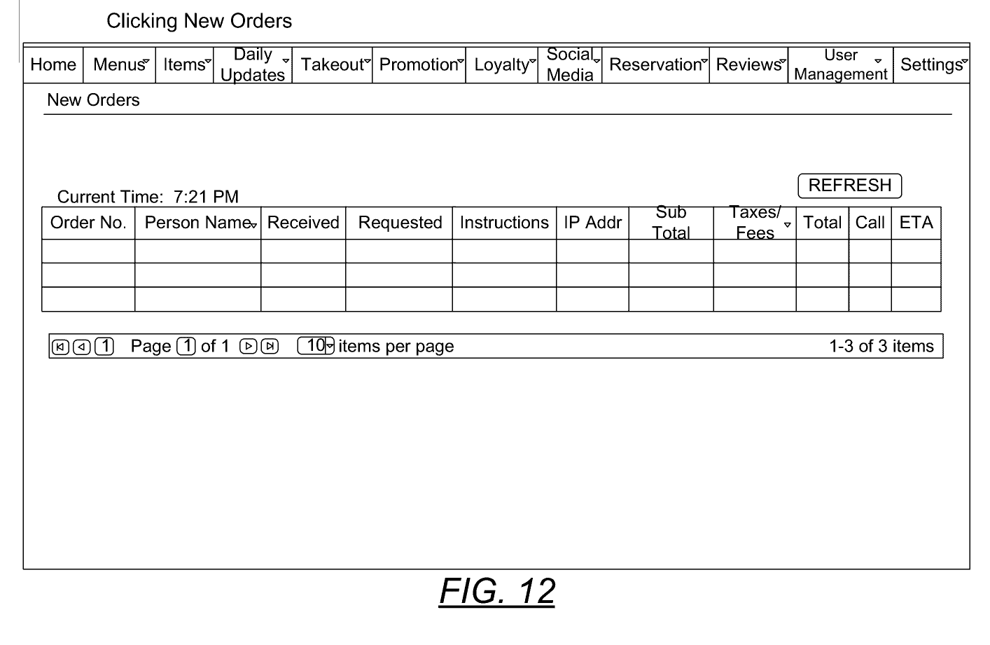

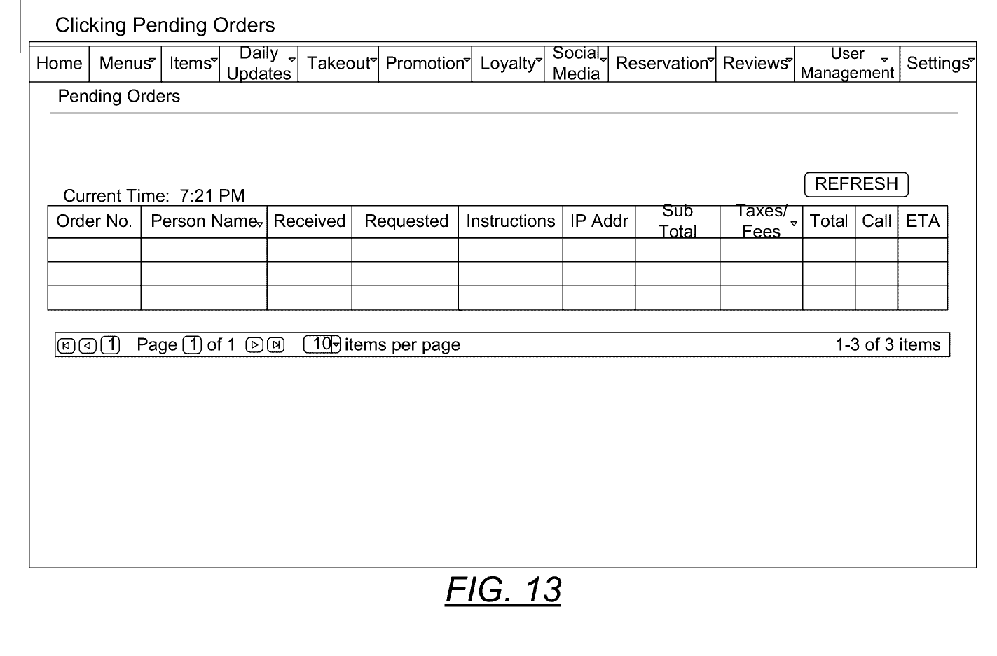

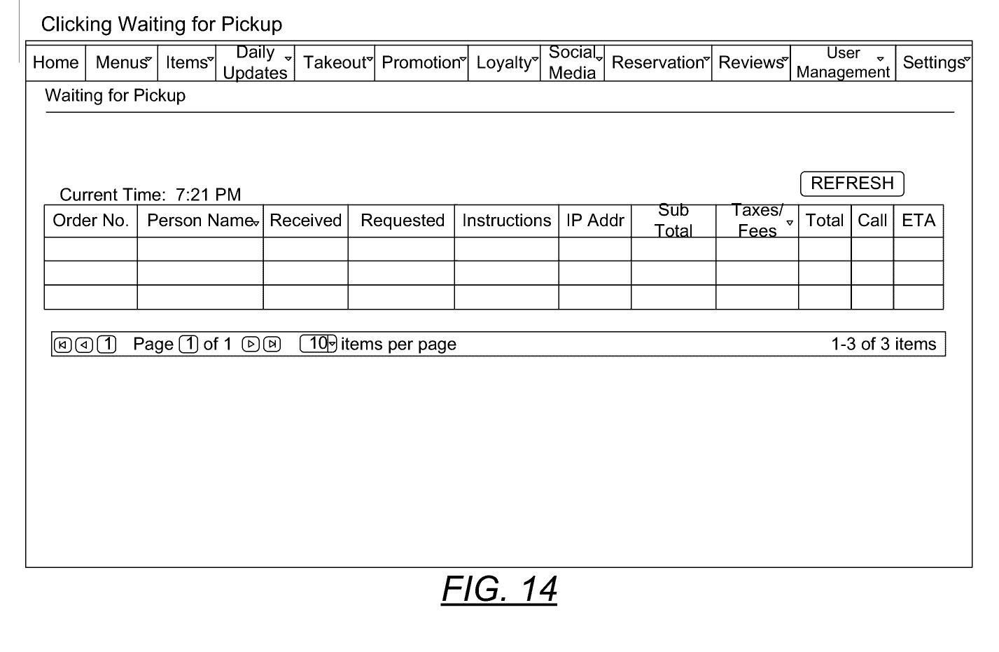

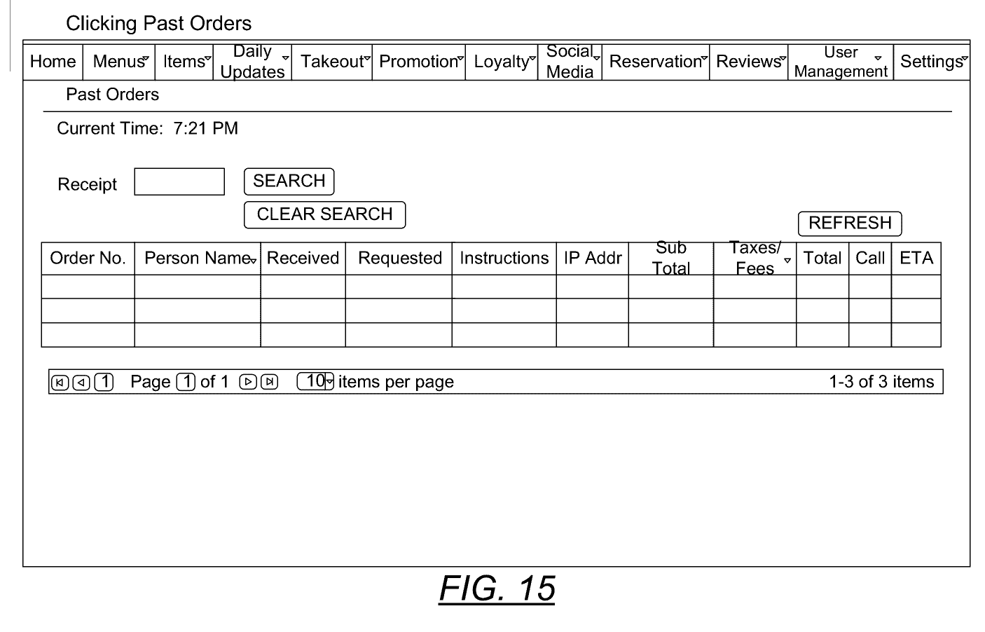

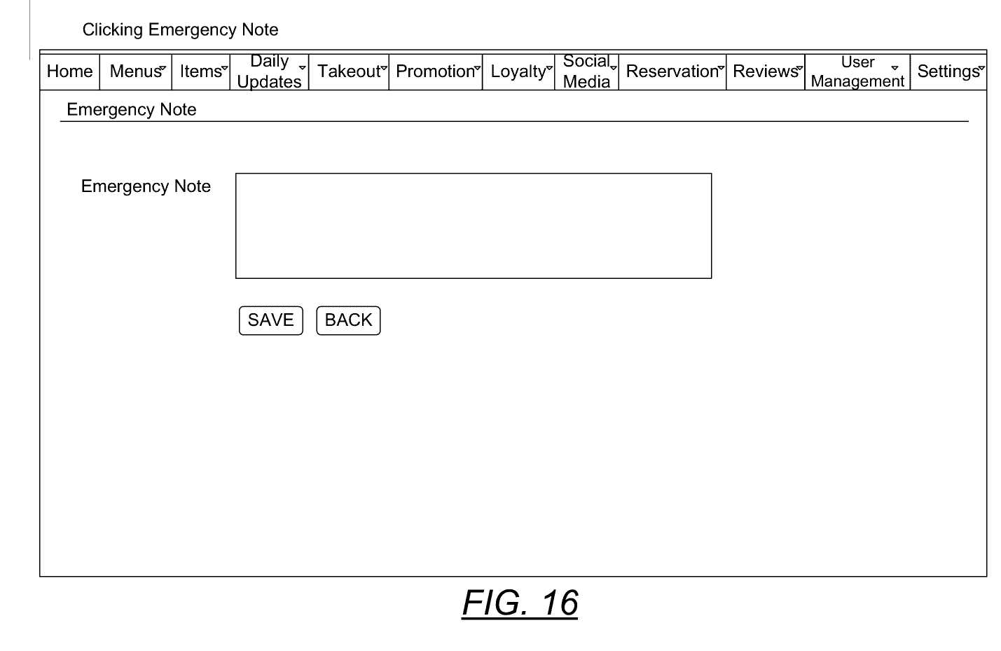

In addition to providing an interface for confirmation of the scheduled offers, the present system and method further allows users to place two-way takeout orders for the items or services of merchants. FIG. 11 is a screenshot of a merchant dashboard, depicting examples of items related to takeout orders revealed as a list. FIG. 12 is a screenshot of a merchant dashboard, depicting examples of items related to new takeout orders. FIG. 13 is a screenshot of a merchant dashboard, depicting examples of items related to pending takeout orders. FIG. 14 is a screenshot of a merchant dashboard, depicting examples of items related to takeout orders waiting for pickup. Traditionally, takeout orders are taken via telephonic communication or in person at a merchant's place of business (either inside the establishment or via a drive-thru apparatus). Often, orders are hand-written on paper and sent to the kitchen. While the magnitude and pervasiveness of errors are unknown, errors do occur due generally to human mistakes. In some cases, no suitable records are kept to help identify opportunities to reduce wait time or optimize the process to deliver food products just-in-time. The present system seeks to remove these sources of errors and is configured receive takeout orders from users. When an order is submitted by a user, pertinent information, e.g., the user's name, the time an order is placed, specific instructions for the order, the price of the item, the Internet Protocol (IP) address of the user's device, and user-entered estimated time of pickup, etc., are stored in the central repository and retrievable at the new or pending orders screen as shown in FIGS. 12 and 13. When an order has been prepared and is ready for pickup, the merchant acknowledges that the order is ready for pickup in the merchant's dashboard and this information is again stored in the central repository and retrievable at the user's display device. In one embodiment, the merchant can also provide the user an estimated time for when an order can be prepared such that the user can avoid arriving too early only to wait for the order to be prepared or too late such that the order becomes cold or stale. Further, the merchant may also retrieve past orders as shown in FIG. 15 that have been serviced to evaluate the effectiveness in item delivery and detect problems associated with the delivery, e.g., delays in getting the item ready, the item is prepared too early rendering it not fresh, etc. FIG. 16 is a screenshot of a merchant dashboard, depicting a mechanism for conveying messages quickly to users. This feature serves to inform users any last-minute status of the condition of the restaurant, food delivery capability or any urgent messages, e.g., early restaurant closure, air-conditioner not working, water main break in the area surrounding the restaurant, etc., such that the user may decide whether or not to continue to place orders or conduct any other activities with the merchant. In one embodiment, no payment information is required when an order is placed. From time to time, fake orders may be placed by users. As the IP address is recorded, culprits may be easily identified and black-listed. In one embodiment, a black list is maintained in the central repository and compared against future orders such that future orders associated with black-listed IP addresses will be ignored and will not be served.

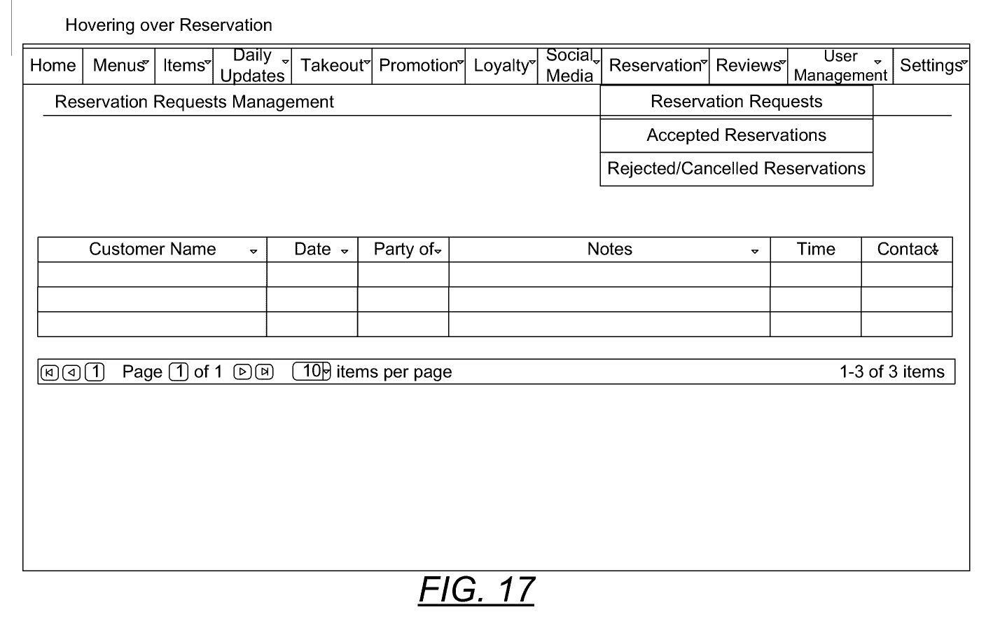

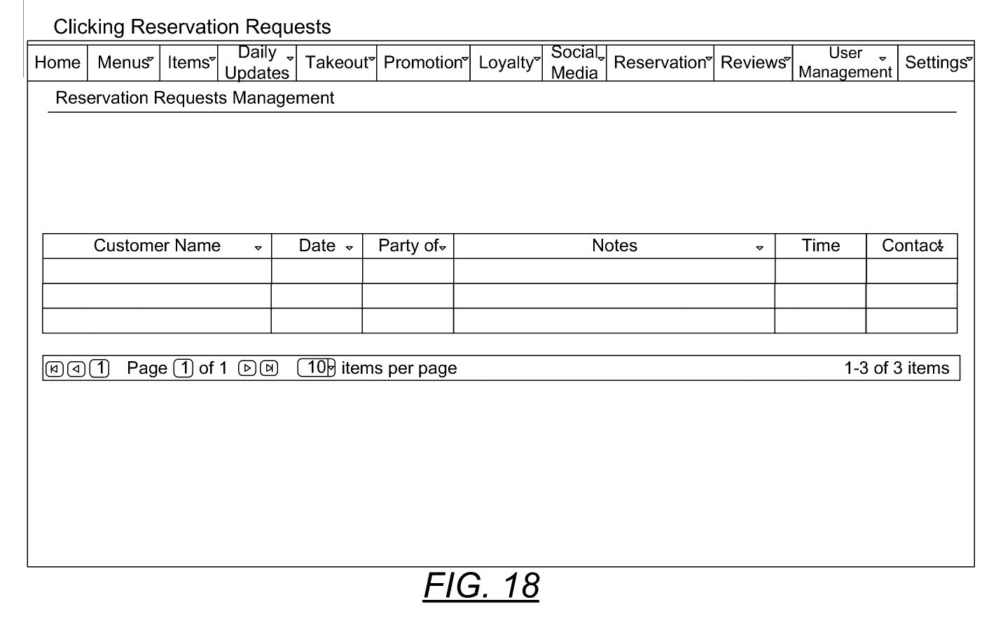

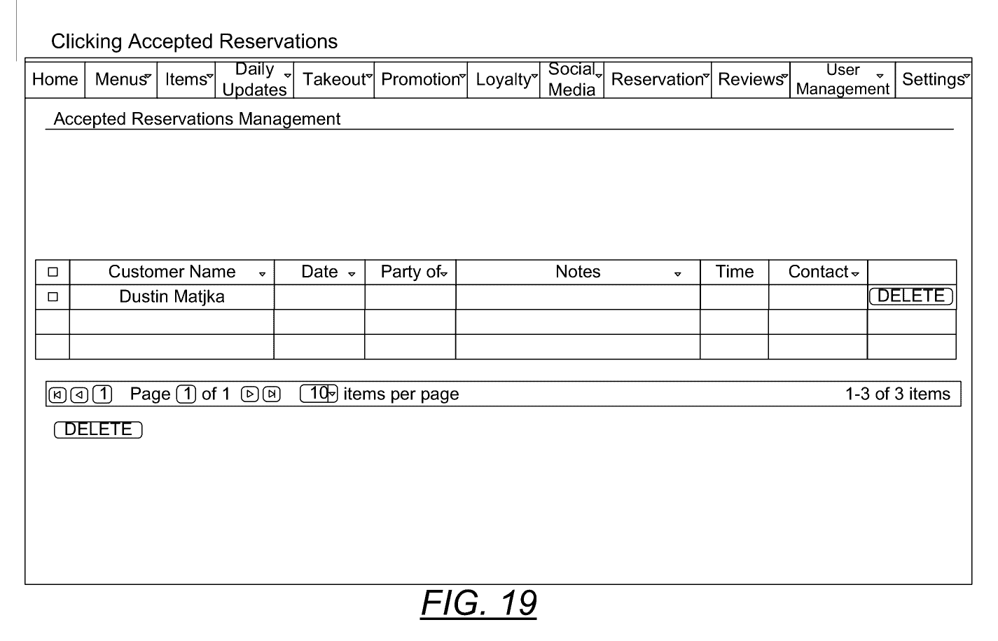

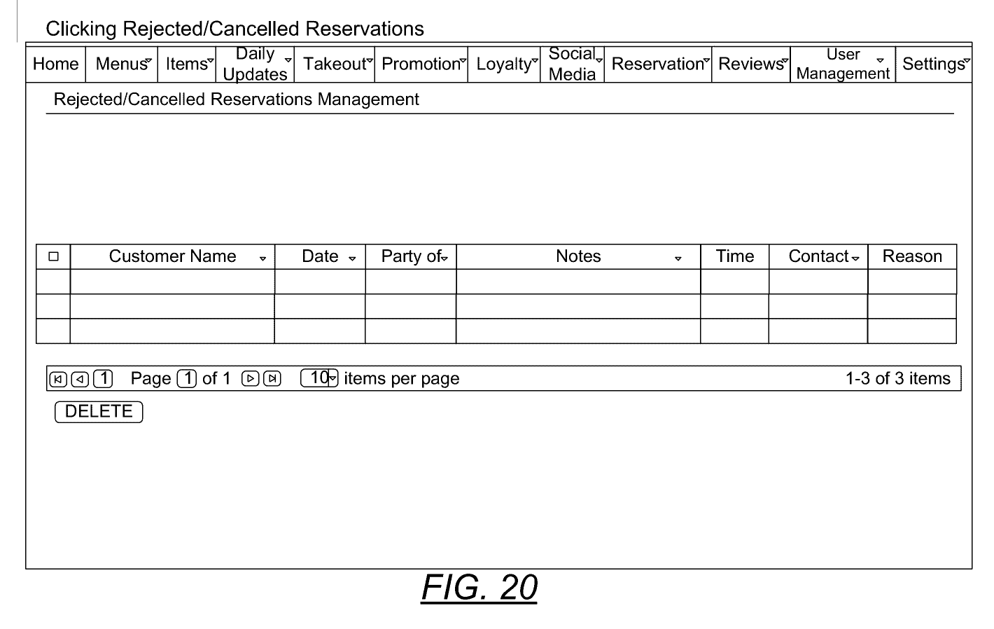

The present system and method further allows users to make reservations for items or services and merchants to respond to such reservations. FIGS. 17-20 depict interfaces related to two-way reservations. FIG. 17 is a screenshot of a merchant dashboard, depicting examples of reservation related items revealed as a list. FIG. 18 is a screenshot of a merchant dashboard, depicting examples of reservation requests. FIG. 19 is a screenshot of a merchant dashboard, depicting examples of accepted reservations. FIG. 20 is a screenshot of a merchant dashboard, depicting examples of rejected/cancelled reservations. A reservation request includes the requester's name, the date and time the reservation is made for, the size of the party for which the reservation is made and the contact information of the requester. Upon accepting a reservation, an indication is reflected in the user's display device. If a reservation is no longer needed, it can be deleted or cancelled by the merchant and again reflected on the user's display device. A reservation may also be rejected by the merchant, the action is again reflected on the user's display device. Cancelled or rejected reservations are stored in the central repository such that they may be retrieved and displayed on the merchant's computer for further analysis.

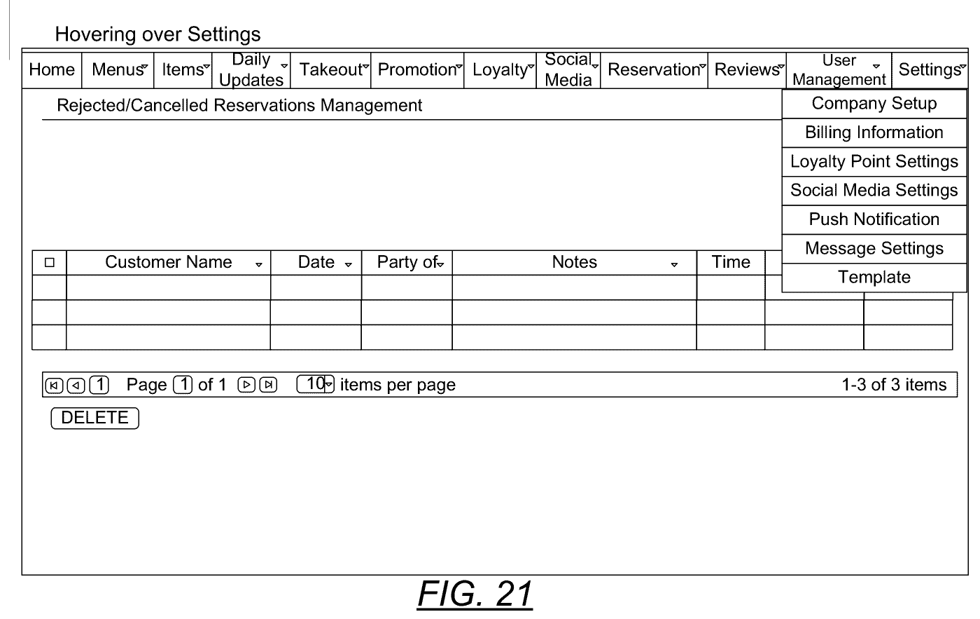

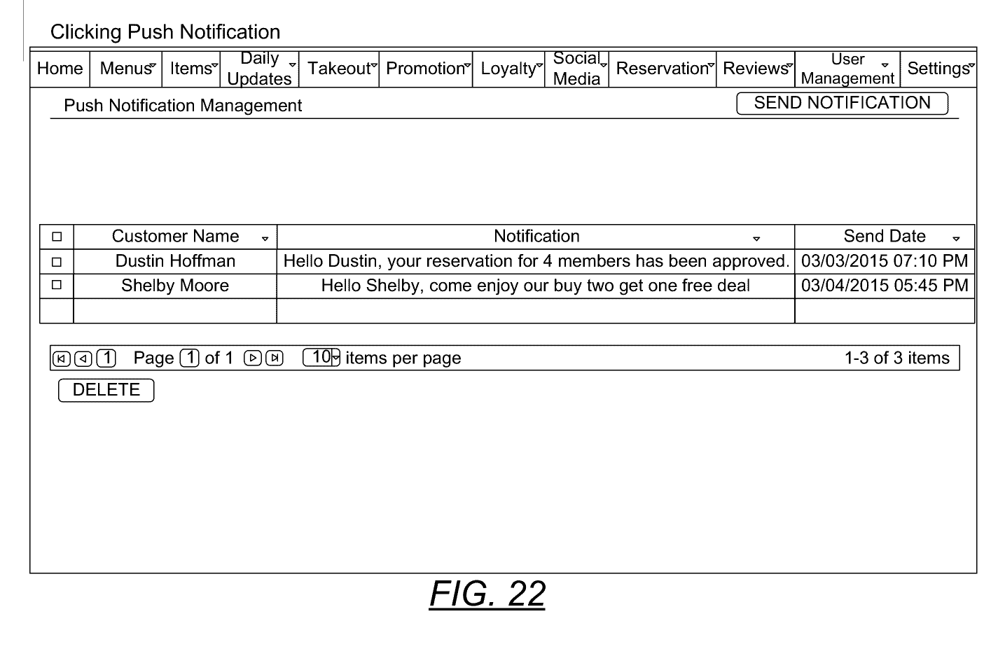

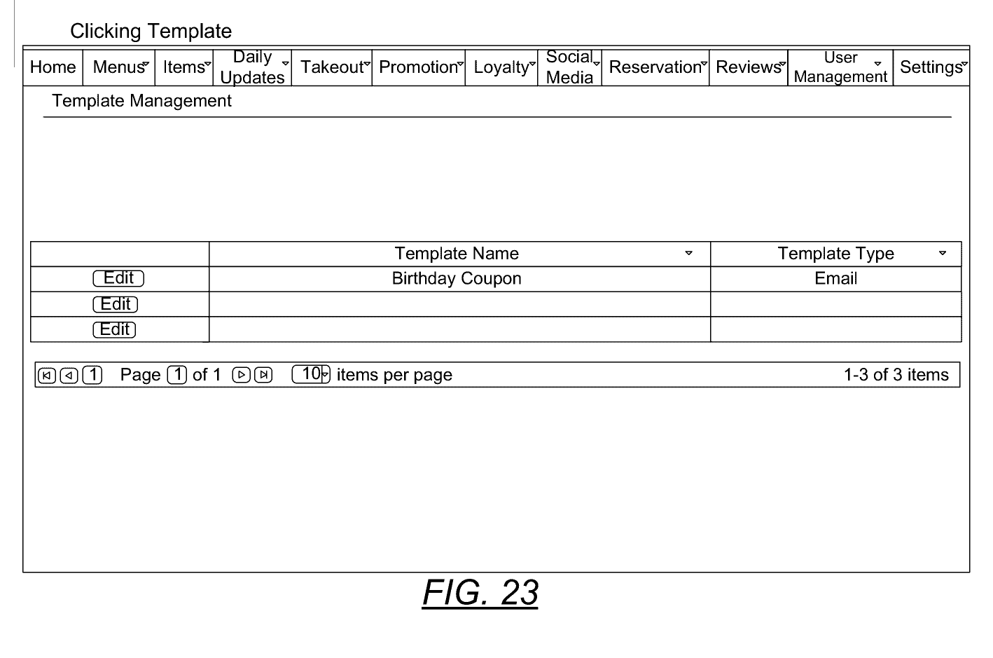

FIG. 21 is a screenshot of a merchant dashboard, depicting examples of settings items for a merchant. The settings include such interfaces as a company setup interface, push notification interface and a template construction interface. The company setup interface includes interfaces for entering information pertaining to the merchant, such as the merchant's address, normal operating hours, operating hours for holidays and amenities, etc. FIG. 22 is a screenshot of a merchant dashboard, depicting examples of push notifications to users. The notifications pushed to users reflect a response sent to a user to confirm that the user's reservation request has been confirmed or the user's takeout order is ready for pickup and an invitation to another user to use a special offer at the merchant's location. In one embodiment, push notifications for special offers are only made to users who have previously opted-in to receive such push notifications. FIG. 23 is a screenshot of a merchant dashboard, depicting examples of a template construction interface. For instance, a birthday coupon has been prepared with the template construction interface where the coupon explains the details of the coupon and it is ready to be pushed to users.

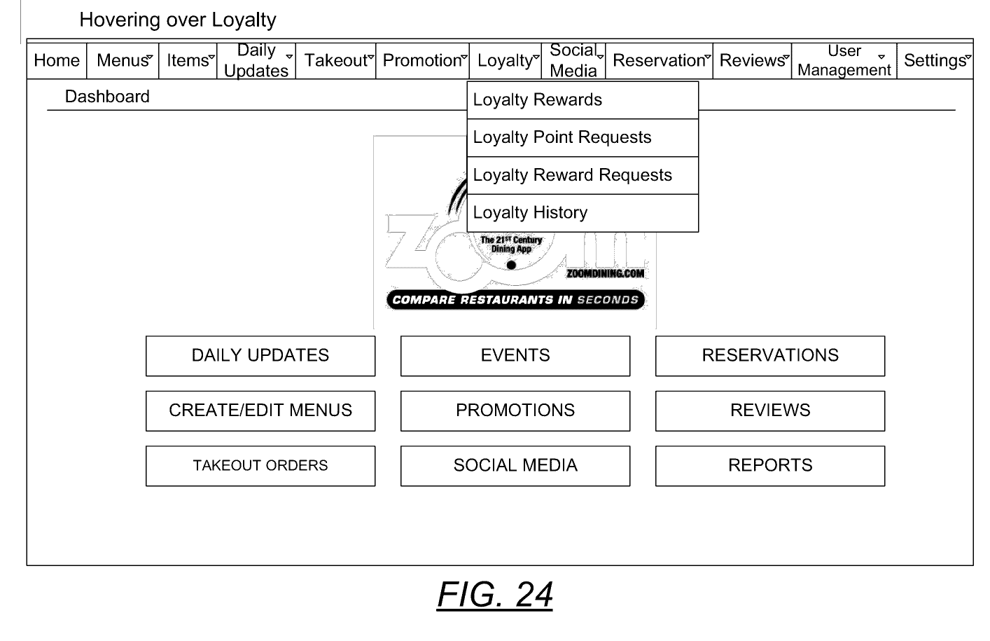

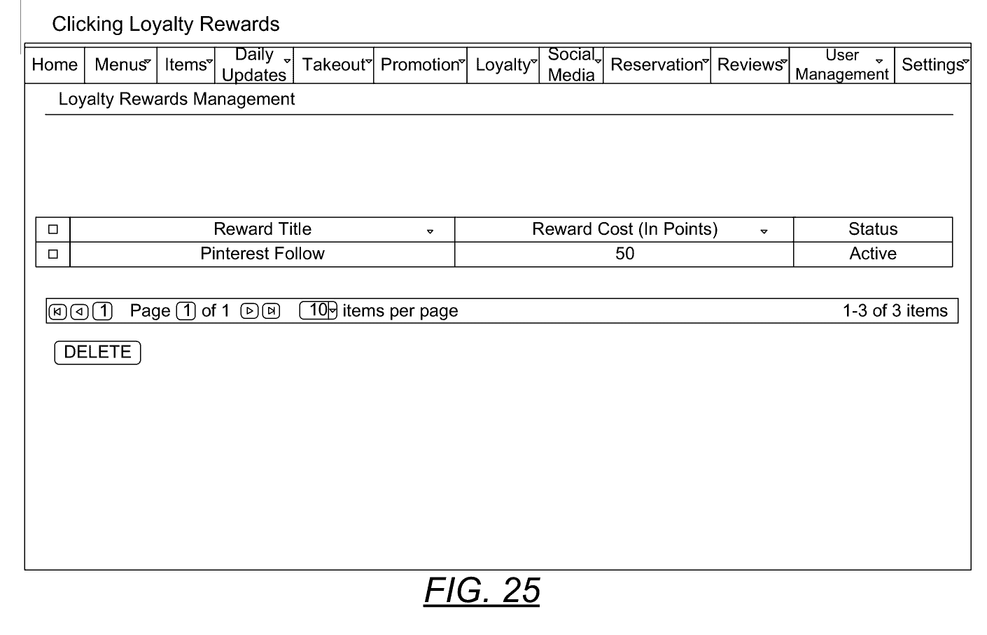

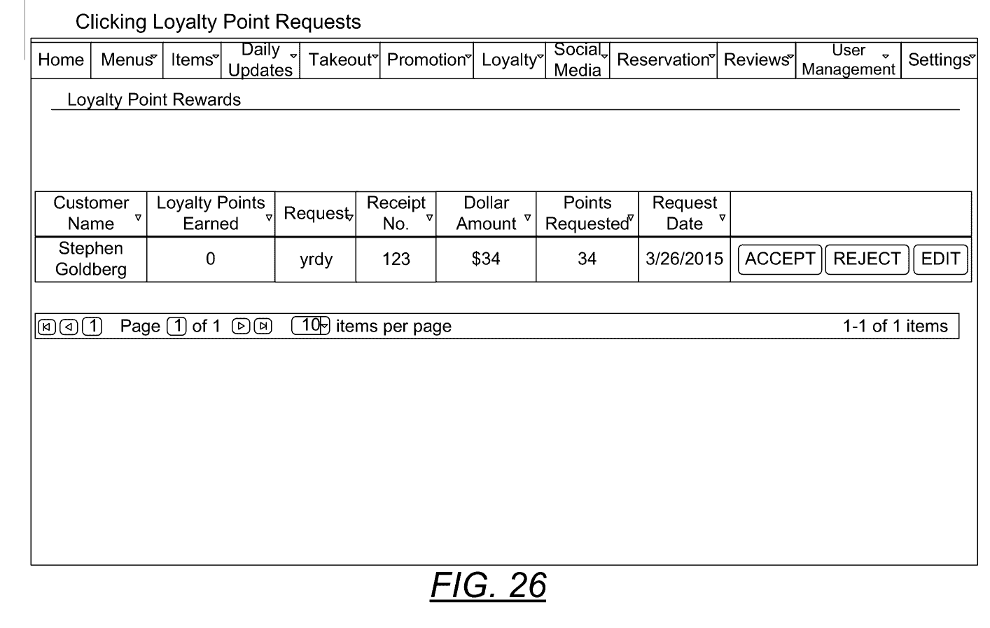

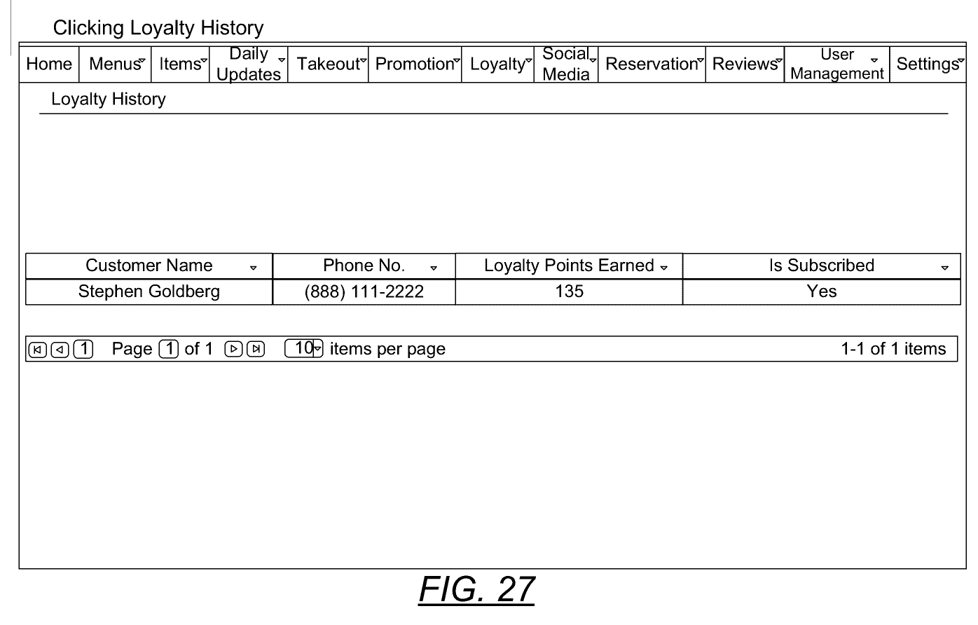

FIG. 24 is a screenshot of a merchant dashboard, depicting examples of items related to loyalty program where the examples are revealed as a list. The list includes such sub-items as “loyalty rewards,” “loyalty point requests,” “loyalty reward requests,” and “loyalty history.” FIG. 25 is a screenshot of a merchant dashboard, depicting examples of items related to loyalty rewards. This screen allows a merchant to quickly get to the source of loyalty reward requests, e.g., from a social media website, etc. FIG. 26 is a screenshot of a merchant dashboard, depicting examples of items related to loyalty point rewards. This screen allows a merchant to view at a glance a list of users who have requested loyalty points and respond to the users' request for loyalty points. Loyalty points may be granted at the point of purchase or after a purchase has been made. A merchant may grant loyalty points automatically to users for takeout orders originating from user accounts of the present system as each order is already associated with a user account. However, for users who otherwise had not established an account at the time of food order may request loyalty points at a later time upon having established their user accounts. The present loyalty reward program allows merchants to track the loyalty reward points of their users and respond to users by granting loyalty points to users without being asked or per their requests, it is a two-way program not available in traditional loyalty reward programs. FIG. 27 is a screenshot of a merchant dashboard, depicting examples of items related to loyalty history. Loyalty programs can have the effect of enabling merchants to acquire new users, increase the spending of existing users, improve the natural churn rate of users and shift spending of users on higher margin products. In general, merchants expect to increase profits by offering loyalty programs. In one embodiment, incentives offered by a specific merchant as part of a loyalty program often come in the form of loyalty points redeemable for a merchandise with the specific merchant. In another embodiment, the present loyalty program allows merchants and users to use a common loyalty program where the loyalty points collected by a user, as a result of doing business with a merchant, can be used not only with the merchant in question, but also with other merchants within the same loyalty program, therefore encouraging its use as the choice of merchandise to users has been broadened. Users having these loyalty points will have more opportunities to use these points as they will be able to use their loyalty points with any merchant. Merchants and users therefore are essentially using a common “currency” that is not in the form of cash but rather restricted to merchandise offered by a group of merchants participating in a loyalty program. Further, the merchant may also view reviews or control whether a review is displayed at a user display device. A review deemed fraudulent or disparaging without a reasonable cause may be deleted. For instance, if reviews are left from a blacklisted user display device, such reviews are not considered genuine and should be deleted. In another embodiment, reviews may not be left from a blacklisted user display device.

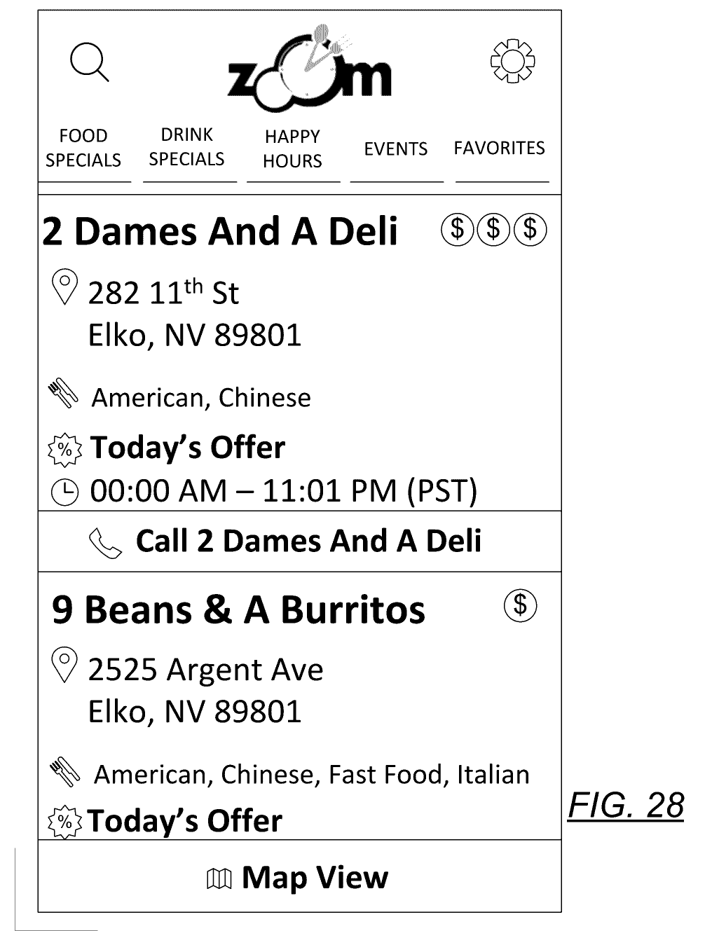

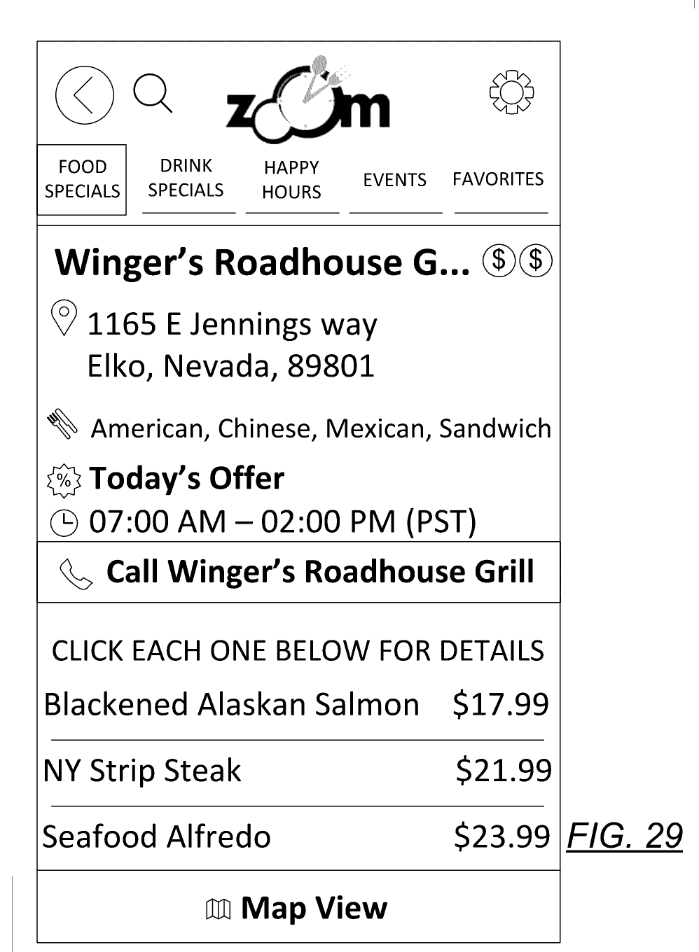

FIG. 28 is a screenshot of a user display device, depicting a default screen displaying a list of merchants in the vicinity of the user display device starting from the merchant closest to the geographical location of the user display device. In determining whether a merchant is listed on the default screen and the order in which the merchant is listed on this default screen, the location of the merchant is first compared to the location of the user display device. If the distance between the merchant and the user display device is within a predetermined threshold, e.g., 20 miles, this distance is compared to distances of other merchants also destined to be displayed. The list is resolved by arranging the merchants with the smallest distances to be put at the top of the list for display on the user display list. The display of a merchant includes, among other information, an address and the type of products this merchant provides, e.g., the type of food served, for instance, American, Chinese, etc. Upon selecting a merchant, a display of a limited number of products offered by the merchant is displayed. In one embodiment, only three items are displayed on the landing page as shown in FIG. 29.

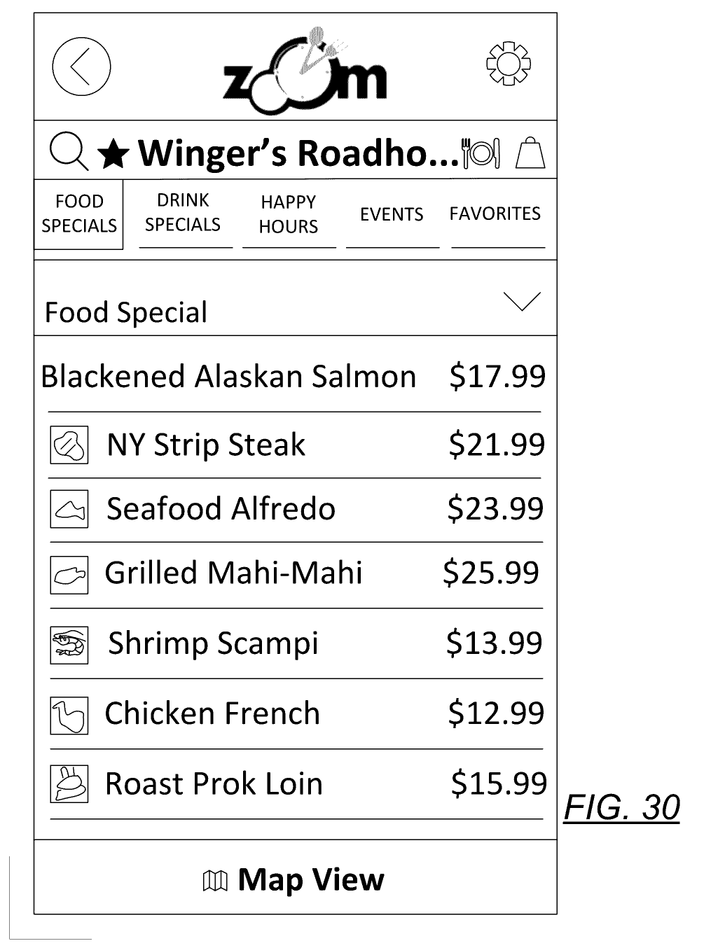

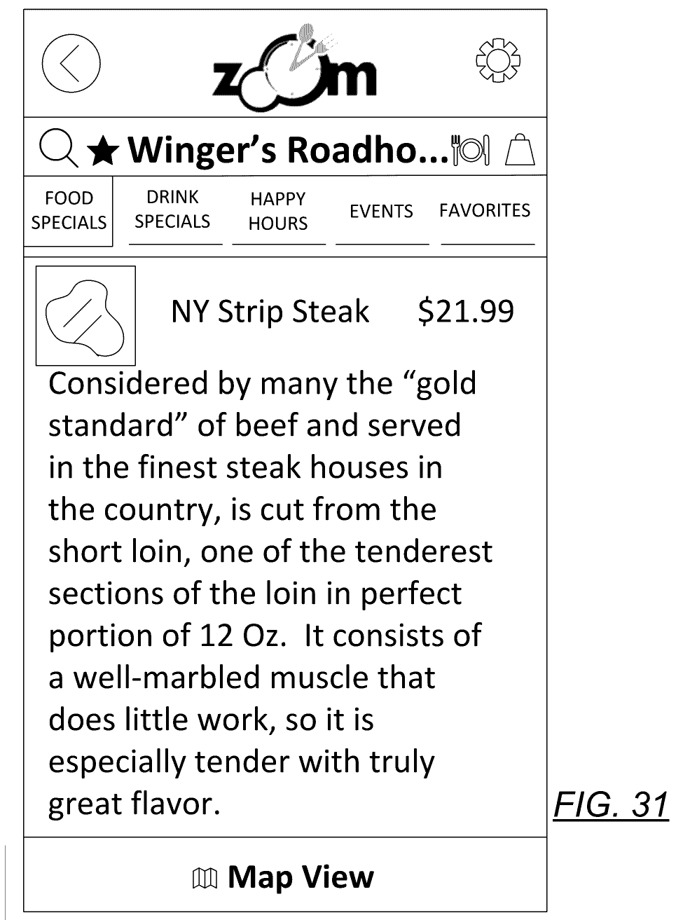

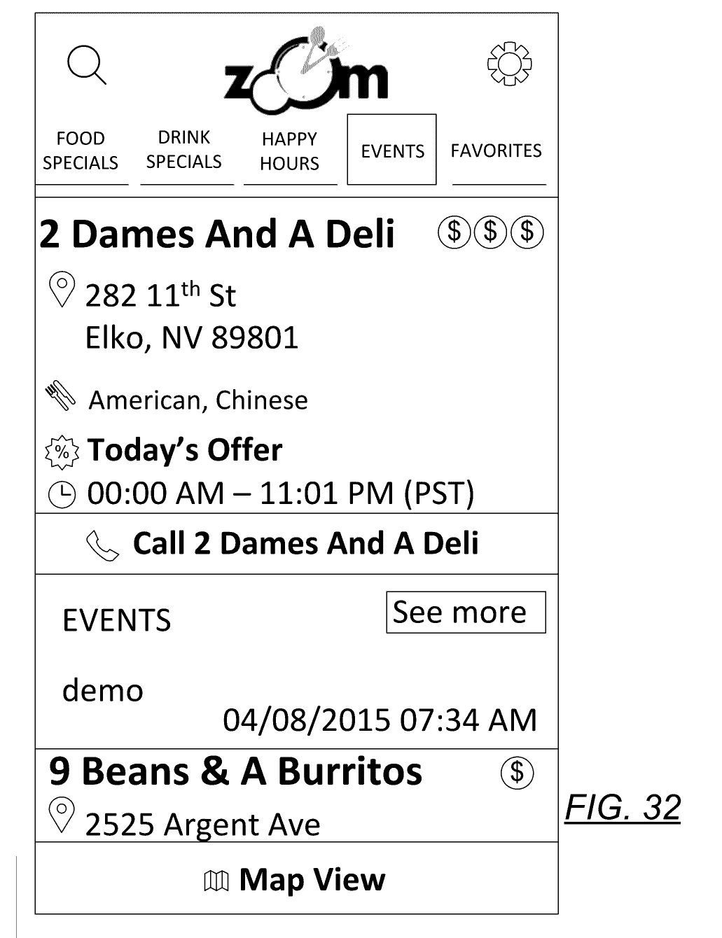

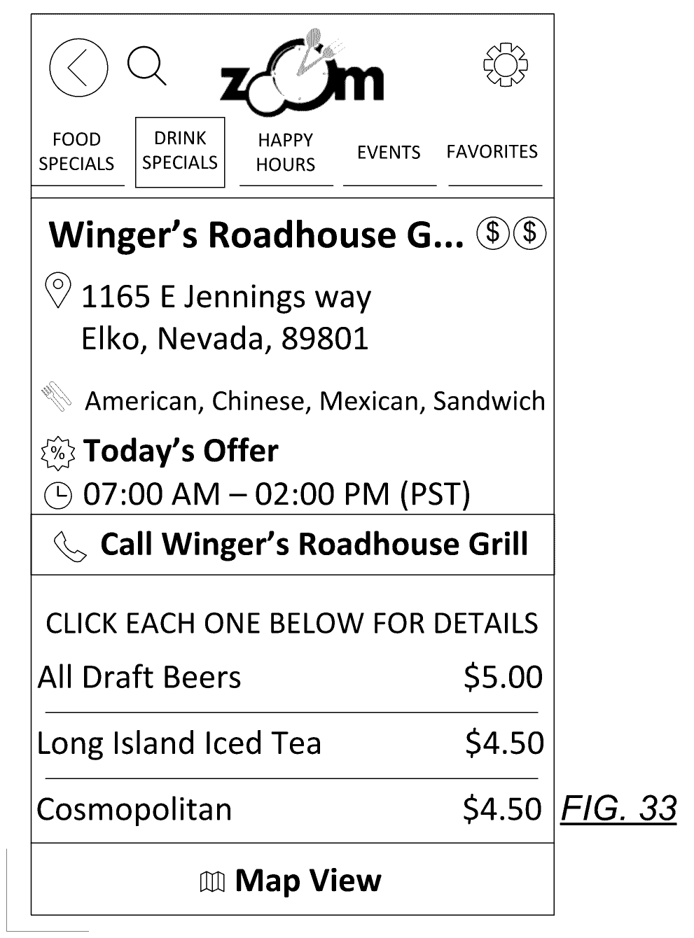

FIG. 29 is a screenshot of a user display device, depicting an example screen displaying a short list of items offered by a merchant, e.g., food specials. The Applicant discovered that by only displaying three items, a user viewing this page is not overwhelmed but is engaged and encouraged to find out more about the full menu by simply pressing a button to reveal more items on the menu as shown in FIG. 30. FIG. 30 is a screenshot of a user display device, depicting an example screen displaying a long list of items offered by a merchant. If the user is interested in getting details about an offered item, the user can then select the item of interest which will lead the user to a description detailing the item as shown in FIG. 31. FIG. 31 is a screenshot of a user display device, depicting an example screen displaying a description detailing an item including such information as the ingredients used in making the item and the portion size, etc. Previously, neither detailed menu items nor complete lists of menu items that are available all at one place have been available to users. Furthermore, the present lists are up-to-date and can be relied upon as the present lists are verified on a daily basis. FIG. 32 is a screenshot of a user display device, depicting another example screen displaying a short list of items of events offered by a merchant. FIG. 33 is a screenshot of a user display device, depicting yet another example screen displaying a short list of items of drink specials offered by a merchant.

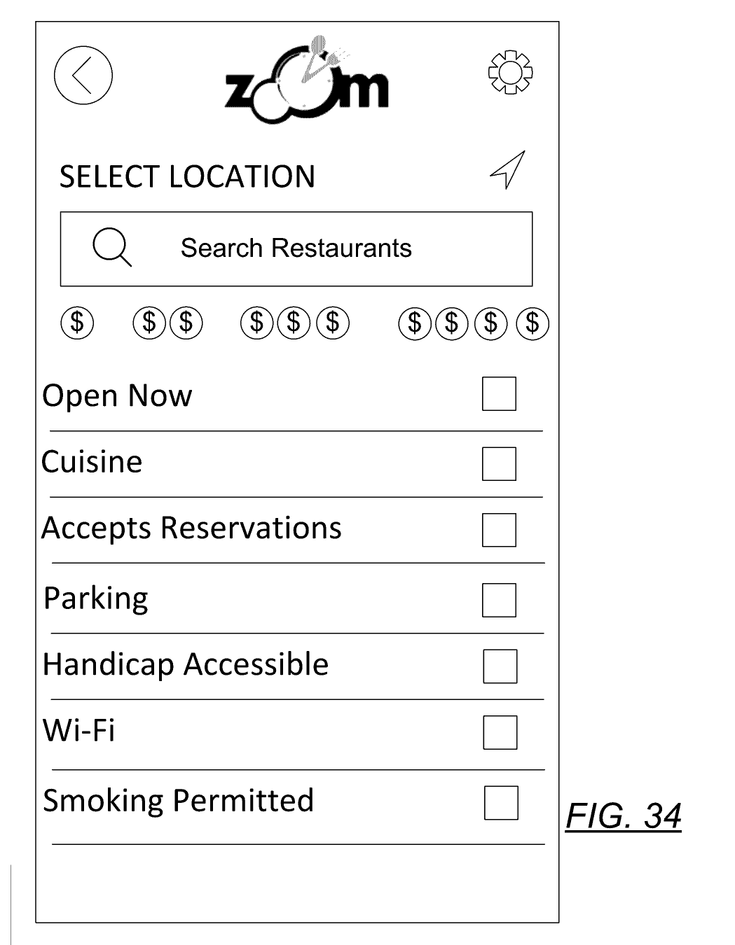

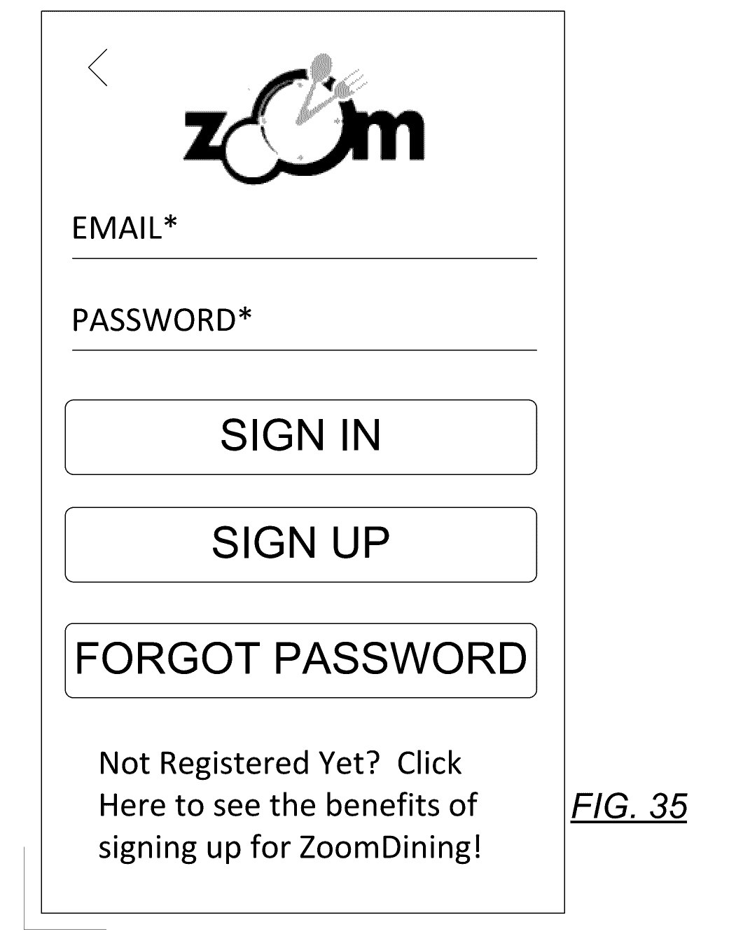

FIG. 34 is a screenshot of a user display device, depicting a search interface available to a user on a display device for merchants meeting listed criteria including relative food price ranges, merchants which are currently open, merchants which accept reservations, merchants which have parking availability, merchants which have handicap accessibility, merchants which have Wi-Fi connectivity, whether smoking is permitted on the merchant's premises, etc. For instance, if the “parking availability” button is selected, a list of merchants having on-premise or off-premise parking will be displayed, again based on their proximity to the location of the user display device. A user can therefore quickly identify merchants meeting the criteria they are searching. FIG. 35 is a screenshot of an account login interface where a logged in user can communicate with a merchant. A login screen enables a user to log into his account so that the user can send reservation request, loyalty point request, etc. or otherwise communicate with a merchant. Each account includes information such as a phone number of a user, an IP address of the user, email address and other information available to a merchant the user communicates with, etc. If communication from a user is considered to be fraudulent, the merchant can refuse to serve the user by identifying the user's IP address to be a black-listed IP address or trace the user via the IP address and add it to a blacklist. The user display device also includes a link to for viewing the locations of merchants on a map called “map view.” This link is placed at a location on the user display device that is easily accessible, for instance, on the bottom edge of the screen of the user display device.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

What is claimed herein is:

1. A method for ensuring display of relevant information on a display device receiving data from a database, said method comprising:
(a) requiring an acknowledgement at a frequency from a responsible party of at least one establishment of a piece of data from the database, said piece of data is associated with an address; and
(b) determining the relevance of said piece of data based on its associated address with respect to the location of the display device,
whereby if said acknowledgement is not received, the piece of data is marked as deactivated in the database such that it is prevented from being presented in the display device and if said piece of data is determined to be relevant, said piece of data is not prevented from being displayed on the display device.

2. The method of claim 1, wherein the information comprises the availability and pricing corresponding to said at least one piece of data of said at least one establishment.

3. The method of claim 1, wherein said at least one establishment is a food establishment.

4. The method of claim 1, wherein the information further comprises the serving size corresponding to said at least one piece of data.

5. The method of claim 1, wherein said frequency is daily.

6. The method of claim 1, wherein the information is displayed in a top-down list format.

7. The method of claim 1, wherein said location is selected from the group consisting of the current location of the display device and specified location.

8. The method of claim 1, wherein the information comprises the availability and pricing of no more than about three items corresponding to said at least one piece of data of said at least one establishment on a landing page.

9. A method for promoting the sale of an item of a merchant at a location to a user, wherein the item is adapted for display on a display device of the user, said method comprising:
(a) requiring an acknowledgement at a frequency from a responsible party of at least one establishment of the item, wherein the item is associated with an address and obtainable at said address;
(b) determining the relevance of the item based on its associated address with respect to the location of the display device of the user; and
(c) enabling a two-way reservation interface, wherein upon display of the item on the display device of the user, a reservation for the location by the user is configured to be placeable through said two-way reservation interface and communicated to the merchant and communication from the merchant is configured to be communicable to the user,
whereby if said acknowledgement is not received, the item is marked as inactive such that it is prevented from being presented in the display device and if the item is determined to be relevant, the item is not prevented from being displayed on the display device.

10. The method of claim 9, wherein the item comprises the availability and pricing of the item.

11. The method of claim 9, wherein the item comprises the serving size of the item.

12. The method of claim 9, wherein said frequency is daily.

13. The method of claim 9, wherein said location of the display device is selected from the group consisting of the current location of the display device and a specified location.

14. The method of claim 9, further enabling a two-way order-placing interface, wherein upon display of the item on the display device of the user, an order for the item is configured to be placeable through said two-way order-placing interface and communicated to the merchant and communication from the merchant is configured to be communicable to the user.

15. The method of claim 9, further enabling a two-way loyalty program, wherein upon the purchase of the item, said two-way loyalty program comprises requesting of loyalty points of the merchant by the user and granting of loyalty points by the merchant to the user.

16. A method for promoting the sale of an item of a merchant at a location to a user, wherein the item is adapted for display on a display device of the user, said method comprising:
(a) requiring an acknowledgement at a frequency from a responsible party of at least one establishment of the item, wherein the item is associated with an address and obtainable at said address;
(b) determining the relevance of the item based on its associated address with respect to the location of the display device of the user;
(c) enabling a two-way reservation interface, wherein upon display of the item on the display device of the user, a reservation for the location by the user is configured to be placeable through said two-way reservation interface and communicated to the merchant and communication from the merchant is configured to be communicable to the user; and
(d) enabling a two-way order-placing interface, wherein upon display of the item on the display device of the user, an order for the item is configured to be placeable through said two-way order-placing interface and communicated to the merchant and communication from the merchant is configured to be communicable to the user,
whereby if said acknowledgement is not received, the item is marked as inactive such that it is prevented from being presented in the display device and if the item is determined to be relevant, the item is not prevented from being displayed on the display device.

17. The method of claim 16, wherein the item comprises the availability and pricing of the item.

18. The method of claim 16, wherein the item comprises the serving size of the item.

19. The method of claim 16, wherein said frequency is daily.

20. The method of claim 16, further enabling a two-way loyalty program, wherein upon the purchase of the item, said two-way loyalty program comprises requesting of loyalty points of the merchant by the user and granting of loyalty points by the merchant to the user.
